(19) United States
(12) Patent Application Publication
(10) Pub. No.: US 2025/0377515 A1
(43) Pub. Date: Dec. 11, 2025

(54) FIBER MANAGEMENT ARRANGEMENTS

(71) Applicant: CommScope Technologies LLC, Hickory, NC (US)

(72) Inventors: Debora DOCKX, Duffel (BE); Jeroen CLAESEN, Leuven (BE); Pieter VERMEULEN, Westerlo (BE); Danny Willy August VERHEYDEN, Gelrode (BE); Johan GEENS, Bunsbeek (BE)

(73) Assignee: CommScope Technologies LLC, Hickory, NC (US)

(21) Appl. No.: 18/877,834

(22) PCT Filed: Jun. 29, 2023
(86) PCT No.: PCT/US2023/069437

§ 371 Date: Dec. 20, 2024

Related U.S. Application Data
(60) Provisional application No. 63/357,109, filed on Jun. 30, 2022.

(51) Int. Cl. G02B 6/44; G02B 6/38

(52) U.S. Cl. CPC G02B 6/44528; G02B 6/3849

(57) ABSTRACT

The present disclosure relates to fiber management systems and methods for facilitating assembling fiber optic devices in an efficient manner by allowing optical fibers to be pre-routed on a flexible substrate such as a film prior to installation in their corresponding fiber optic devices. The flexible substrate can include unitary flaps for providing a variety of functions such as substrate positioning and spacing, temporary connector storage, fiber bend radius protection, fiber holding, and optical component holding.

### CROSS-REFERENCE TO RELATED APPLICATION

This application is being filed on Jun. 29, 2023, as a PCT International application and claims the benefit of and priority to U.S. Provisional Application Ser. No. 63/357,109, filed Jun. 30, 2022, the disclosure of which is hereby incorporated by reference in its entirety.

### TECHNICAL FIELD

The present disclosure relates generally to fiber routing systems for telecommunication equipment. More particularly, the present disclosure relates to fiber routing systems that use flexible substrates such as polymeric films.

### BACKGROUND

Telecommunication systems typically employ a network of telecommunication cables capable of transmitting large volumes of data and voice signals over relatively long distances. The telecommunication cables can include fiber optic cables, electrical cables, and/or combinations of electrical and fiber optic cables. A typical telecommunication network also includes a plurality of telecommunication enclosures integrated throughout the network of telecommunication cables. The telecommunication cables are often terminated by connectors such as fiber optic connectors. The fiber optic connectors can include single-fiber fiber optic connectors and multiple-fiber fiber optic connectors. Fiber optic connectors are adapted for making de-mateable fiber optic connections between two optical fibers or between two sets of optical fibers. Fiber optic connectors are often coupled together via fiber optic adapters, but certain fiber optic connectors can be directly coupled together without the use of fiber optic adapters.

One example type of enclosure frequently used in a telecommunication system is a multi-service terminal (MST). A multi-service terminal is frequently used near the outer edge of a telecommunication network to provide optical connection points for coupling subscribers to the network via drop cables. A typical multi-service terminal includes a plurality of connector ports that are accessible from outside the terminal. Each of the connector ports is adapted for receiving a ruggedized fiber optic connector that terminates the end of a drop cable. The opposite end of the drop cable is often connected to a subscriber location to connect the subscriber location to the telecommunication network. Example multi-service terminals are disclosed by U.S. Pat. Nos. 7,653,282; 7,397,997; 7,903,923; 7,489,849; and 7,512,304 and are also disclosed by International PCT Publication Nos. WO2019/040742 and WO2019/195602.

Flexible films have been used to support and manage optical fiber routing within telecommunications devices such as modules (e.g., see U.S. Publication No. 2015/0260927 and International PCT Publication Nos. WO 2019/070682; WO 2014/055859; WO 2018/085767; and WO 2021/217079). Aspects of the present disclosure relate to enhancements in this area.

### SUMMARY

One aspect of the present disclosure relates to fiber management systems and methods for facilitating assembling fiber optic devices in an efficient manner by allowing optical fibers to be pre-routed prior to installation in their corresponding fiber optic devices. In certain examples, the pre-routed optical fibers can be pre-terminated with fiber optic connectors. In certain examples, the optical fibers can be pre-routed on a polymeric substrate that can be a flexible polymeric sheet (e.g., film) that may be cut (e.g., stamped, laser cut, etc.) from a larger sheet (e.g., an extruded sheet) or can be a molded part. In certain examples, the polymeric substrates can have openings corresponding to connector mounting locations of the fiber optic devices. In certain examples, the polymeric substrates can include main bodies on which the optical fibers are routed, and can include unitary flaps for providing functions such as spacing functions for positioning the substrates horizontally and vertically within their corresponding devices, holding functions for holding optical fibers and/or fiber optic components, fiber guiding functions for guiding fibers around bends, strain relief functions for supporting optical fibers routed to locations such as connector mounting locations, and storage functions for temporarily storing connectorized ends of the optical fibers. The flaps can be connected to a main body of the substrate by flexible regions (e.g., fold lines forming living hinges) about which the flexible regions can be bent (e.g., folded).

A variety of additional aspects will be set forth in the description that follows. The aspects can relate to individual features and to combinations of features. It is to be understood that both the forgoing general description and the following detailed description are exemplary and explanatory only and are not restrictive of the broad inventive concepts upon which the examples disclosed herein are based.

### BRIEF DESCRIPTION OF THE DRAWINGS

FIG. 1 is a perspective view of a telecommunication enclosure including a fiber management arrangement in accordance with the principles of the present disclosure.

FIG. 2 is an exploded view of the telecommunication enclosure of FIG. 1.

FIG. 3 is a perspective view of an inside of a cover of the telecommunication enclosure of FIG. 1.

FIG. 4 is a cross-sectional view of an example fiber optic adapter configuration for fiber optic adapters that can be carried with the cover of the enclosure of FIG. 1.

FIG. 5 is a perspective view of an example hardened fiber optic connector that can be mated with an external port of the fiber optic adapter of FIG. 4.

FIG. 6 is a perspective view showing a first side of a flexible polymeric substrate suitable for use as part of the telecommunication enclosure of FIGS. 1 and 2, the substrate is shown in a folded state.

FIG. 7 is another perspective view showing the first side of the flexible polymeric substrate of FIG. 6 with the substrate in the folded state.

FIG. 8 is a perspective view showing a second side of a flexible polymeric substrate of FIG. 6 with the substrate shown in the folded state.

FIG. 9 is another perspective view showing the second side of a flexible polymeric substrate of FIG. 6 with the substrate shown in the folded state.

FIG. 10 is a plan view showing the first side of the flexible polymeric substrate of FIG. 6 in the folded state.

FIG. 11 is a plan view showing the second side of the flexible polymeric substrate of FIG. 6 in the folded state.

FIG. 12 is a first end view of the flexible polymeric substrate of FIG. 6 in the folded state.

FIG. 13 is a second end view of the flexible polymeric substrate of FIG. 6 in the folded state.

FIG. 14 is a first side view of the flexible polymeric substrate of FIG. 6 in the folded state.

FIG. 15 is a second side view of the flexible polymeric substrate of FIG. 6 in the folded state.

FIG. 16 is a plan view of an alternative fiber management arrangement in accordance with the principles of the present disclosure suitable for use with the telecommunication enclosure of FIGS. 1 and 2, the fiber management arrangement includes a flexible polymeric substrate shown in a non-folded state.

FIG. 17 is a plan view depicting the fiber management arrangement of FIG. 16 in a folded state and installed in the cover of the telecommunication enclosure of FIGS. 1 and 2, with fiber optic connectors of the fiber management arrangement shown plugged into fiber optic adapters carried with the cover.

FIG. 18 is a perspective view depicting the fiber management arrangement of FIG. 16 in a folded state and installed in the cover of the telecommunication enclosure of FIGS. 1 and 2, with fiber optic connectors of the fiber management arrangement shown plugged into fiber optic adapters carried with the cover.

FIG. 19 is a side view of one of the fiber optic connectors of the fiber management arrangement of FIG. 16.

FIG. 20 is a side view of the fiber optic connector of FIG. 19 loaded into a dust cap of the fiber management arrangement of FIG. 16.

FIG. 21 is a perspective view of the fiber optic connector of FIG. 19 loaded into the dust cap of the fiber management arrangement of FIG. 16.

FIG. 22 is a perspective view showing fiber optic connectors of the fiber management arrangement of FIG. 16 staged within dust caps secured on the flexible polymeric substrate.

FIG. 23 is a perspective view illustrating a fiber guide of the fiber management arrangement of FIG. 16.

FIG. 24 is a perspective view depicting holders in accordance with the principles of the present disclosure for holding structures such as optical fibers and optical components.

FIG. 25 is a plan view of the substrate of the fiber management arrangement of FIG. 16 prior to folding.

FIG. 26 depicts a further fiber management arrangement in accordance with the present disclosure having fiber optic connectors staged at a removable connector staging portion.

FIG. 27 depicts the fiber management arrangement of FIG. 26 with the fiber optic connectors removed from the removable connector staging portion.

### DETAILED DESCRIPTION

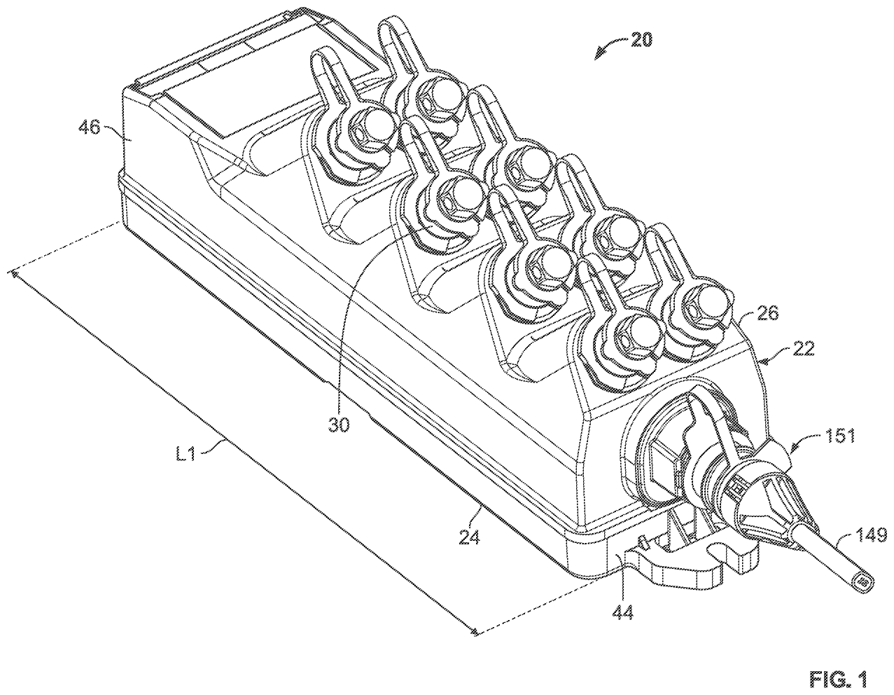

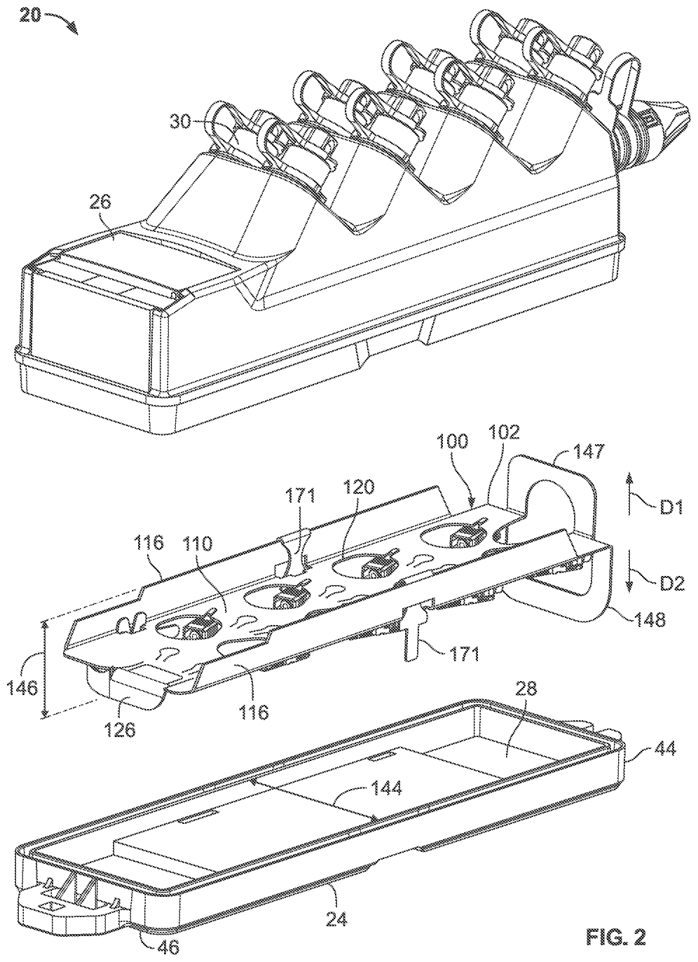

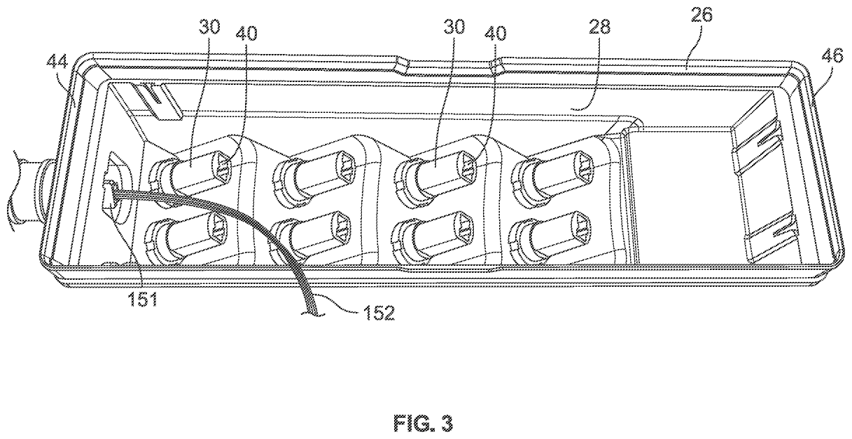

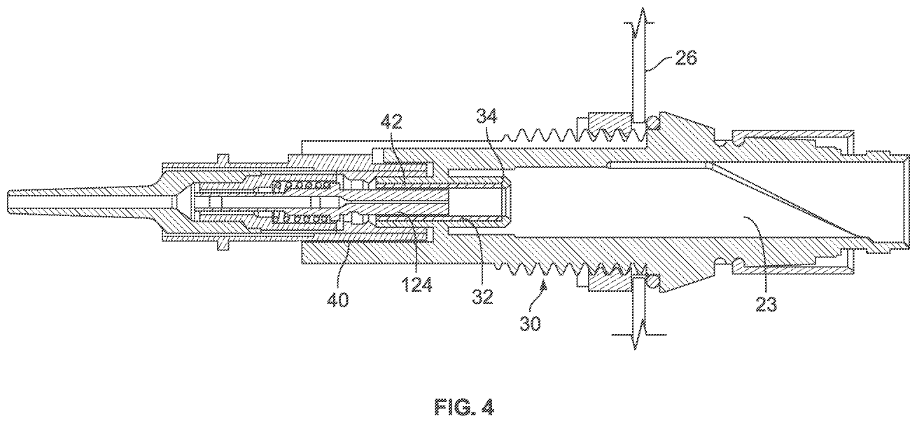

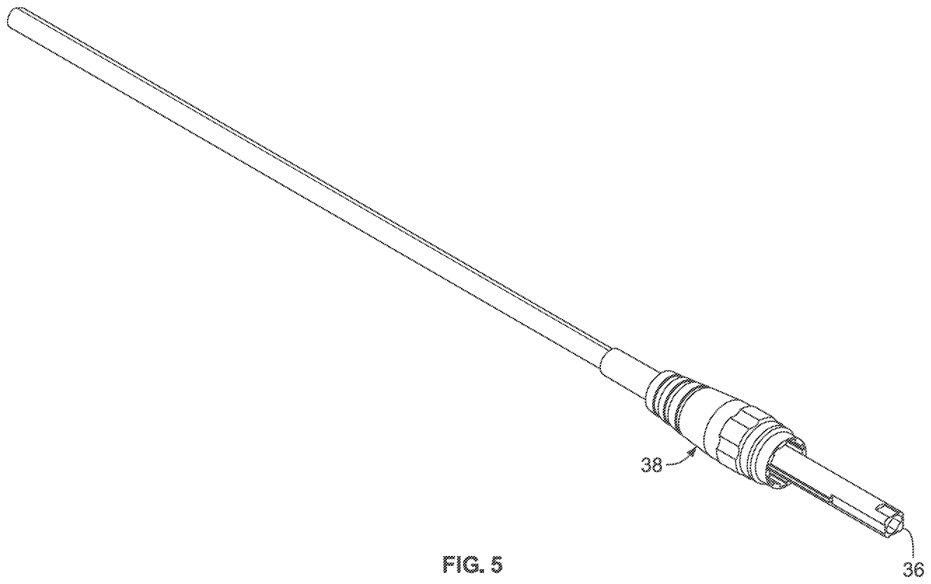

FIGS. 1-3 depict a telecommunication enclosure 20 in accordance with the principles of the present disclosure. The telecommunication enclosure 20 includes a housing 22 having a base 24 and a cover 26 that fit together to enclose an interior 28 of the housing 22. The telecommunication enclosure 20 includes a plurality of fiber optic adapters 30 carried with the cover 26. The fiber optic adapters 30 include ferrule alignment sleeves 32 (see FIG. 4) having outer ends 34 for receiving ferrules 36 (see FIG. 5) of hardened connectors 38 inserted into the fiber optic adapters 30 from outside the housing 22 (e.g., through external connector ports 23). The fiber optic adapters 30 also include inner connector mounting locations 40 corresponding to inner ends 42 of the ferrule alignment sleeves 32. Referring to FIG. 1, the housing 22 defines a housing length L1 that extends between first and second opposite housing ends 44, 46 of the housing 22.

The telecommunication enclosure 20 can include a fiber management arrangement that mounts within the housing 22 between the base 24 and the cover 26. As disclosed herein, first and second different fiber management arrangements 100, 200 are disclosed. The first and second fiber management arrangements 100, 200 have similar configurations but include polymeric substrates 102, 104 having slightly different configurations. Common features of the polymeric substrates 102, 104 and other common features of the fiber management arrangements 100, 200 will be assigned the same reference numbers for ease of explanation. The polymeric substrates 102, 104 are depicted having one material thickness and are preferably formed from polymeric sheets (e.g., films) which can be folded to provide three-dimensional structural features for providing various functions. In one example, the polymeric substrates 102, 104 can be cut (e.g., stamped, laser cut, etc.) from larger sheets of material (e.g., extruded sheets of material). In other examples, the polymeric substrates 102, 104 or polymeric substrates having varying material thicknesses can be made through molding processes.

The polymeric substrates 102, 104 each include a main body 110. The fiber management arrangements 100, 200 each include a plurality of optical fibers 112 routed on and secured to the main body 110. The main body 110 is elongate along a manager length L2 adapted to extend along the housing length L1. The polymeric substrates 102, 104 include sides 114 that extend along the manager length L2. The polymeric substrates 102, 104 include side flaps 116 that extend along the sides 114 and are connected to the main body 110 by side-flap living hinges 118. The side flaps 116 are folded in a first direction D1 relative to the main body 110 at the slide flap living hinges 118 and are adapted to extend from the main body 110 into the cover 26. The main body 110 defines through openings 120 corresponding to the inner connector mounting locations 40 through which the optical fibers 112 can be routed, such that connectorized ends 122 of the optical fibers 112 can be plugged into the inner ends 42 of the ferrule alignment sleeves 32 at the inner connector mounting locations 40. In certain examples, the connectorized ends 122 can include non-hardened fiber optic connectors such as SC connectors or LC connectors. The connectors of the connectorized ends 122 can include ferrules 124 supported at distal ends of connector bodies of the fiber optic connectors. The ferrules 124 are received within the inner ends 42 of the ferrule alignment sleeves 32 when the connectors forming the connectorized ends 122 are plugged into their corresponding inner connector mounting locations 40. The ferrules 124 support ends of the optical fibers 112.

In certain examples, the polymeric substrates 102, 104 can each include a fiber guide flap 126 attached to the main body 110 by a guide flap living hinge which may include a flex region 127a for providing a more gradual bend as compared to a discrete fold line. At least one of the optical fibers 112 is routed on and attached to the fiber guide flap 126. The at least one optical fiber 112 can be attached to the fiber guide flap 126 by intermittent volumes of adhesive or by continuous sections of adhesive. The adhesive can be permanent or can be tacky enough to hold the optical fiber in place while allowing the optical fiber to be manually removed from the fiber guide flap 126. In certain examples, a plurality of the optical fibers 112 are routed on the fiber guide flap 126. In the depicted example, optical fibers 112 corresponding to each of the connector mounting locations 40 are routed onto the fiber guide flap 126. The fiber guide flap 126 is bent at the flex region 127a in a second direction D2 opposite from the first direction D1 relative to the main body 110 to form a side wall 128 that extends along a portion of a perimeter of the main body 110. The fiber guide flap 126 includes a first guide flap portion 129 connected to the main body 110 by the flex region 127a including flexible bridge portions 131 separated by a gap 135. The fiber guide flap 126 also includes a second guide flap portion 130 which is not connected to the main body 110 along its length. Instead, the second guide flap portion 130 can be bent relative to the main body 110 along its length and is capable of being bent relative to the first guide flap portion 129 in a curved configuration to transition optical fibers 112 about a corner of the main body 110 and a corner of the housing 22. The fiber or fibers 112 can be routed on the second guide flap portion 130 as well as the first guide flap portion 129. By orienting the second guide flap portion 130 along a curve by bending the second guide flap portion 130 relative to the first guide flap portion 129, the second guide flap portion 130 can function to guide the fiber or fibers 112 along a curve. In certain examples, the curve can be used to facilitate reversing a direction of the optical fibers 112. As depicted, the curve of the flap portion 130 is about a 90 degree curve to transition the fibers 112 about a corner, and the entire fiber guide flap 126 assists in transitioning the optical fibers 112 about 180 degrees from a first fiber direction FD1 to a second fiber direction FD2. The second guide flap portion 130 can include a retention tab 132 that fits within the gap 133 defined by the main body 110 to retain the second guide flap portion 130 in the curved configuration.

The optical fibers 112 can be secured to the main body 110 by discrete sections 134 (e.g., dots) of adhesive positioned intermittently along the lengths of the optical fibers 112. In certain examples, the lengths of the optical fibers 112 between the adhesive sections are longer than the adhesive sections themselves. In alternative examples, extended lengths of the optical fibers 112 can be bonded to the main body 110 by lines of adhesive or by sheets/layers of adhesive coated on the substrate sheet itself. In certain examples, different types of adhesive can be utilized. For example, the discrete sections 134 of adhesive can be more permanent than other adhesives that may be utilized. In certain examples, the other adhesive may have tacky characteristics that allow optical fibers to be removably held at desired locations.

In certain examples, the polymeric substrates 102, 104 can include fiber strain relief flaps 136 positioned adjacent to the through openings 120. The strain relief flaps 136 can include flap lengths L3 that extend between base ends 137 unitarily formed with the main body 110 and free ends 138. The optical fibers 112 can be routed along the flap lengths L3 and bonded to a corresponding one of the strain relief flaps 136. The strain relief flaps 136 each extend toward a corresponding one of the through openings 120 in a direction from the base end 137 to the free end 138. The free ends 138 of the strain relief flaps 136 can include enlarged heads 139 and dots 140 of adhesive can be provided on the enlarged heads 139 for bonding the optical fibers 112 to the enlarged heads 139. In the depicted example, the enlarged heads 139 are circular in shape.

In certain examples, the first and second fiber management arrangements 100, 200 can include dust caps 141 secured to the main body 110 adjacent to the through openings 120 for receiving and storing the connectorized ends 122 of the optical fibers 112 prior to the connectorized ends 122 being routed through the through openings 120 and plugged into the connector mounting locations 40. The dust caps 141 are depicted secured to the main body 110 on opposite sides of the through openings 120 from the strain relief flaps 136. The dust caps 141 can be configured to receive the ferrules 124 of the fiber optic connectors defining the connectorized ends 122. The connectorized ends 122 can be keyed with respect to the dust caps 141 so that the connectorized ends 122 are permitted to be inserted into the dust caps 141 in only one rotational orientation. In certain examples, one of the connectorized ends 122 and the dust cap 141 has a key slot and the other of the connectorized ends 122 and the dust cap 141 has a mating key projection. The keyed positioning of the connectorized ends 122 within the dust caps 141 can be coordinated with keyed positions of the connectorized ends 122 within the connector mounting locations 40 to facilitate transferring the connectorized ends 122 from the dust caps 141 to the connector mounting locations 40 in a repeatable motion. In certain examples, the dust caps 141 define ferrule staging axes 142 along which the ferrules 124 of the connectorized ends 122 align when stored in the dust caps 141. The staging axes 142 can be obliquely oriented relative to the main body 110 of the polymeric substrates 102, 104. The oblique orientation of the dust caps 141 can facilitate a smooth transition of the optical fibers 112 from the strain relief flaps 136 to the connectorized ends 122.

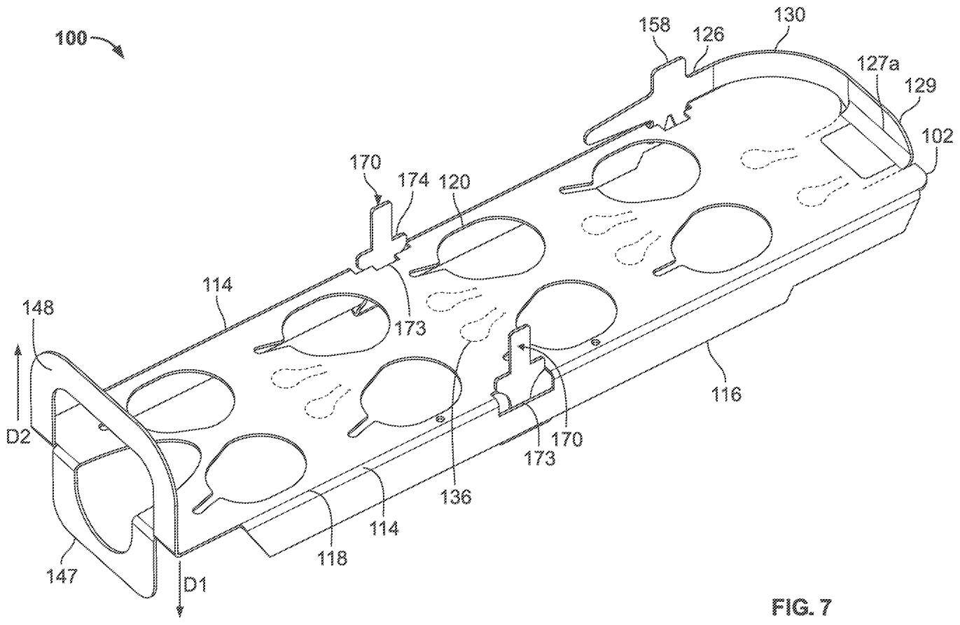

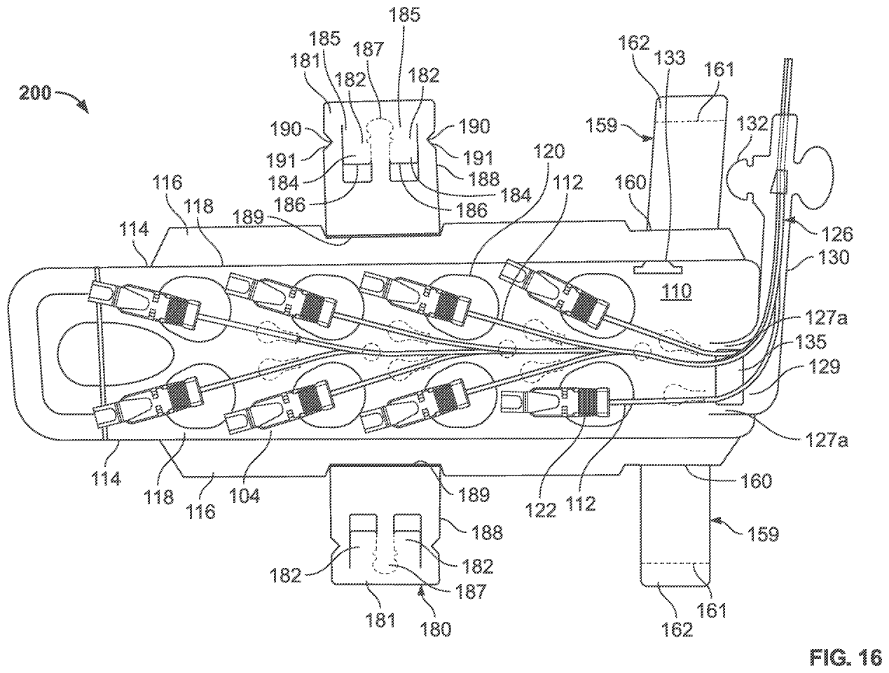

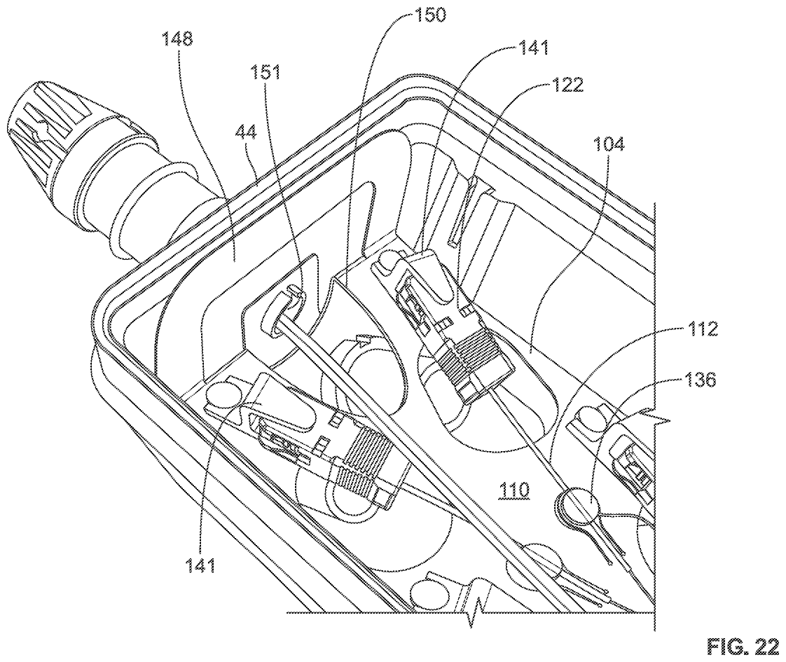

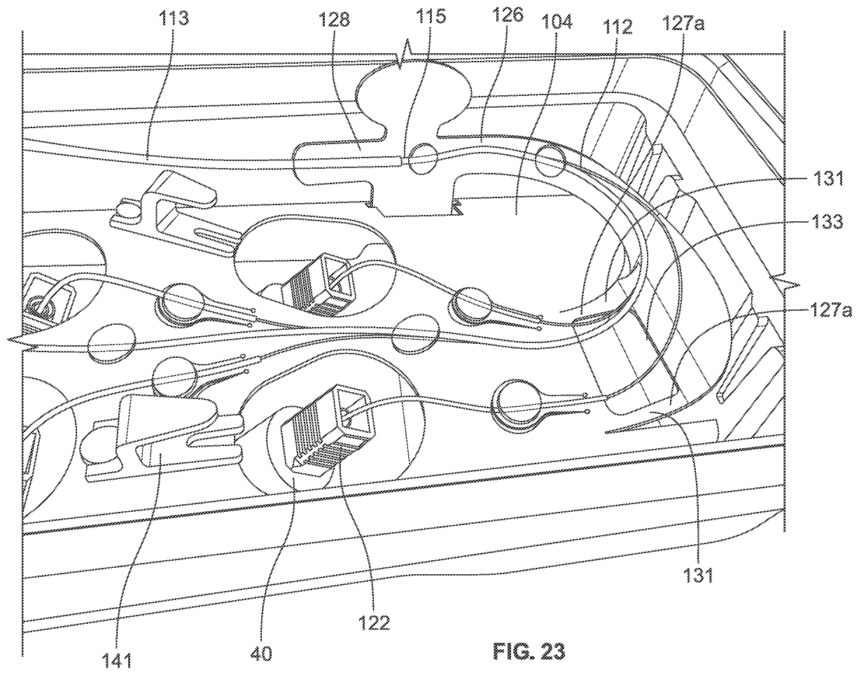

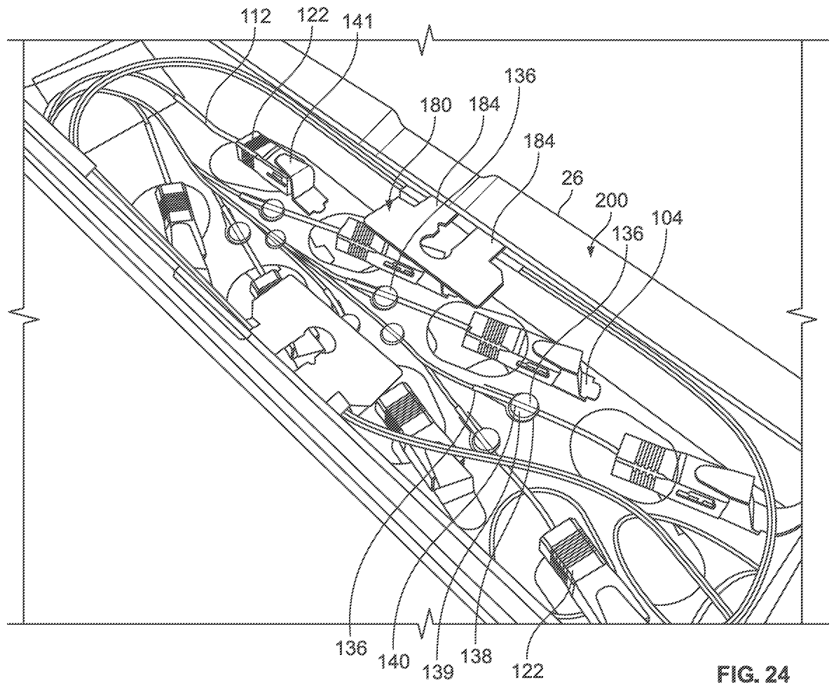

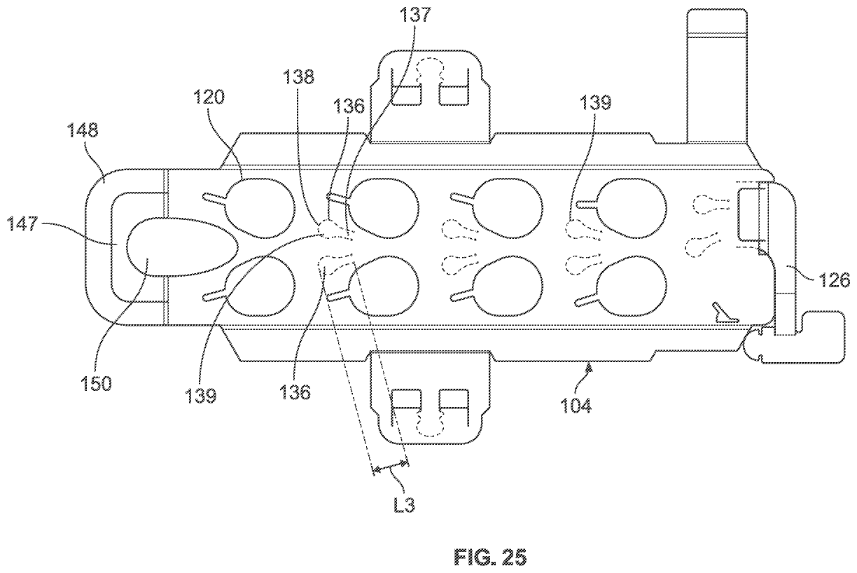

The polymeric substrates 102, 104 can include foldable structures for assisting in positioning the polymeric substrates 102, 104 within the housing 22. For example, the side flaps 116 can assist in positioning the polymeric substrates 102, 104 along a first orientation 144 between opposite sides of the housing 22. Additionally, the polymeric substrates 102, 104 can include foldable flaps adapted for positioning the main bodies 110 of the polymeric substrates 102, 104 along a second orientation 146 between the base 24 and the cover 26. The foldable flaps can have fold lines defined between the flaps and the main bodies 110. In the depicted examples, first and second spacer flaps 147, 148 are provided for spacing the main bodies 110 between the base 24 and the cover 26 along the second orientation 146. The first spacer flap 147 is adapted to be folded about a fold line relative to the main body 110 in the first direction D1 and is adapted to contact the cover 26, and the second spacer flap 148 is adapted to be folded about a fold line relative to the main body 110 in the second direction D2 and is adapted to contact the base 24. The first and second spacer flaps 147, 148 are located at one end of the main body 110 and are each depicted having a U-shape. As depicted at FIG. 25, the first spacer flap 147 is nested inside the second spacer flap 148 prior to folding. The first spacer flap 147 cooperates with the main body 110 to define a fiber pass-through opening 150 before and after folding. The fiber pass-through opening 150 can align with a cable entrance location 151 located at the first housing end 44 (see FIG. 22). In certain examples, the polymeric substrates 102, 104 can include additional spacers for spacing the main body 110 along the second orientation 146. In certain examples, the spacers can be located near the second end 46 of the housing 22 while the first and second spacer flaps 147, 148 are located adjacent the first end 44 of the housing 22. For example, referring to FIG. 7, a spacer tab 158 for engaging the base 24 can be integrated as part of the fiber guide flap 126. Also, as shown at FIG. 16, spacer flaps 159 at an opposite side of the main body 110 for spacing the main body 110 along the second orientation 146 in the vicinity of the second end 46 of the housing 22 can include fold lines 160 located at free ends of the side flaps 116 for allowing the spacer flaps 159 to be folded in the second direction D2. The spacer flaps 159 can further include fold lines 161 for folding the spacer flaps 159 to form end tabs 162 at free ends of the spacer flaps 159 that oppose the base 24.

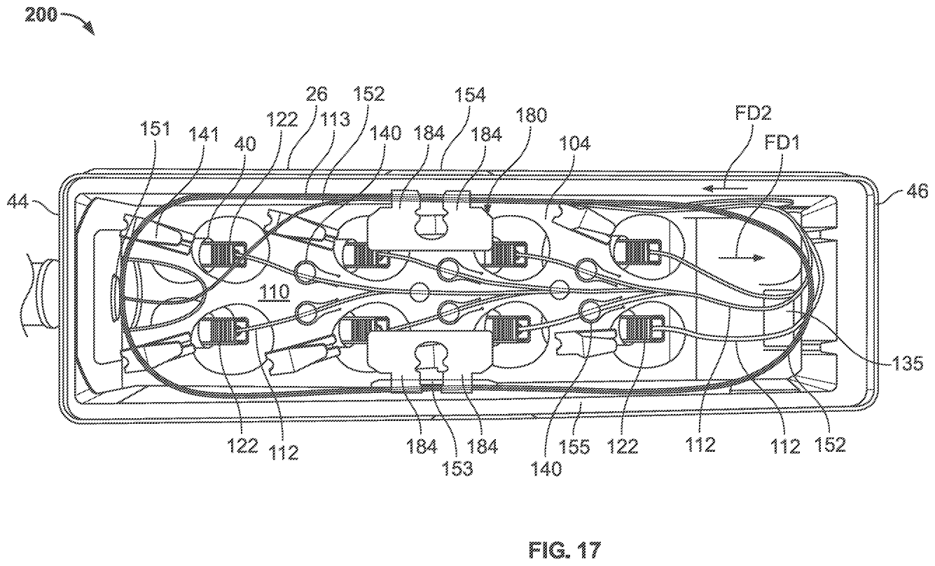

An input cable 149 can enter the housing 22 through the cable entrance location 151 at the first housing end 44. Optical fibers 152 (e.g., in loose or ribbon form) of the cable 149 can pass through the fiber pass-through opening 150 and can be spliced to the optical fibers 112 at a splice location 153 which may be protected by a splice protection package (e.g., a heat shrink sleeve which surrounds the splice and contains adhesive and a reinforcing member). In other examples, the cable 149 incudes at least one optical fiber with the optical fiber being spliced to the input of a passive optical splitter and outputs of the passive optical splitter being spliced to the optical fibers 112 having the connectorized ends 122. As shown at FIG. 17, the optical fibers 112 can be routed from their corresponding inner connector mounting locations 40 in the fiber direction D1 (e.g., a direction away from the input cable 149) toward the second housing end 46. At the second housing end 46, the optical fibers 112 can reverse direction along the fiber guide flap 126 and can be routed in the second fiber direction FD2 along the housing length L1 at a first housing side 154 of the housing 22. The optical fibers 112 can transition from a loose form to a ribbonized form, ribbonized fibers 113, at a transition location 115 secured to the fiber guide flap 126 (e.g., by an adhesive dot). At the first housing end 44, the ribbonized fibers 113 can reverse directions from the fiber direction FD2 to the fiber direction FD1 and can be routed along the housing length L1 at an opposite second housing side 155 of the housing 22. Along the second housing side 155, the optical fibers 112,113 can be optically spliced to the optical fibers 152 of the input cable 149 at the splice location 153. The optical fibers 152 can be routed from the splice location 153 along the second housing side 155 in the second fiber direction FD2, can reverse direction to the first fiber direction FD1 at the second housing end 46 and can be routed along the first housing side 154. From the first housing side 154, fibers 152 can extend across the main body 110 and through fiber pass-through openings 150 adjacent the first housing end 44. As depicted at FIG. 17, the optical fibers 112, 113, 152 can be routed in a looped configuration about the perimeter of the housing 22 and about a perimeter of the main body 110. In this way, excess fiber length can be stored about the perimeter the main body 110.

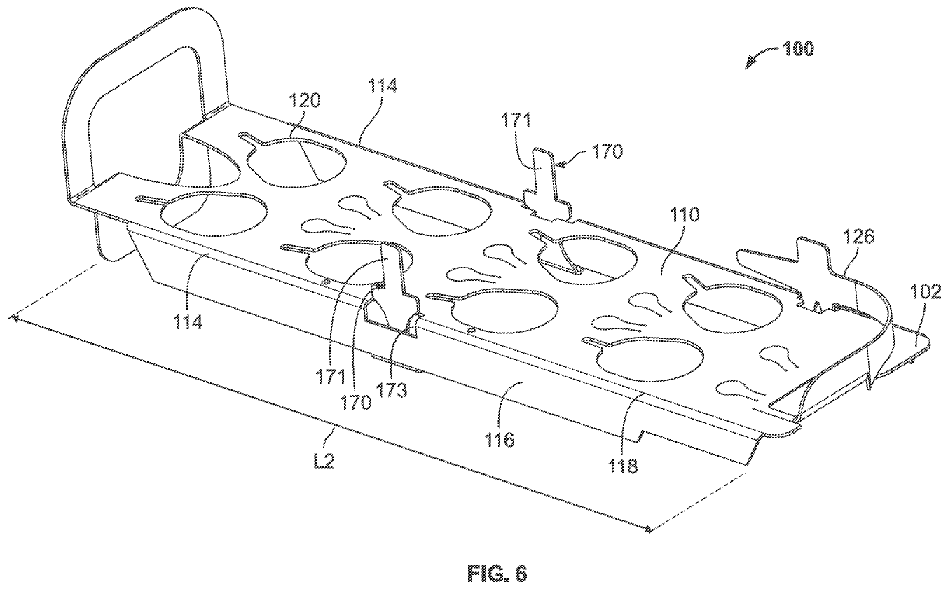

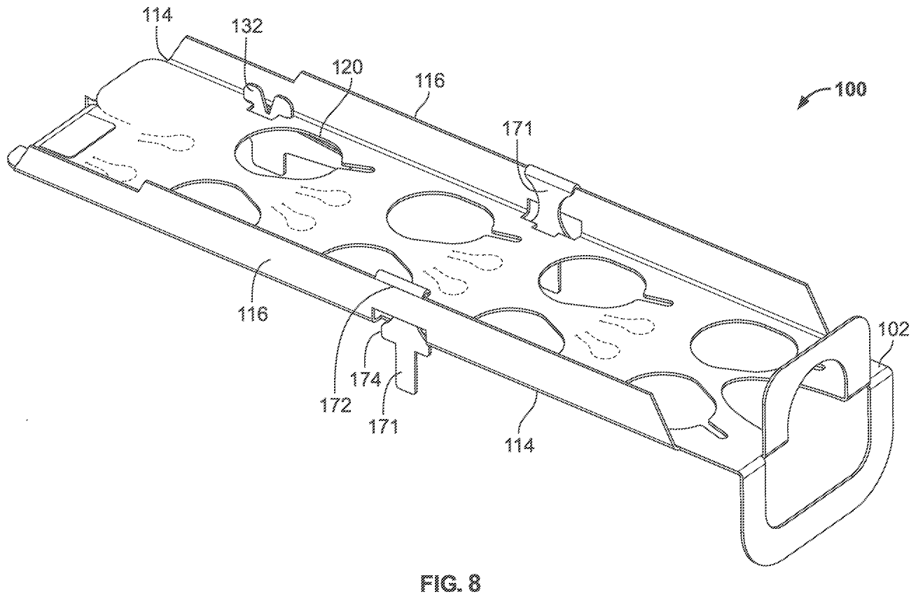

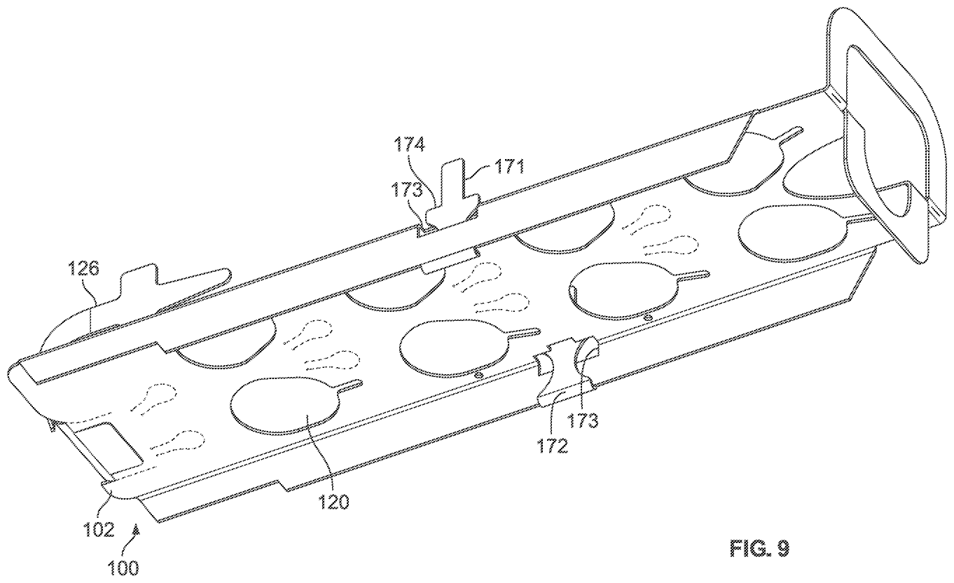

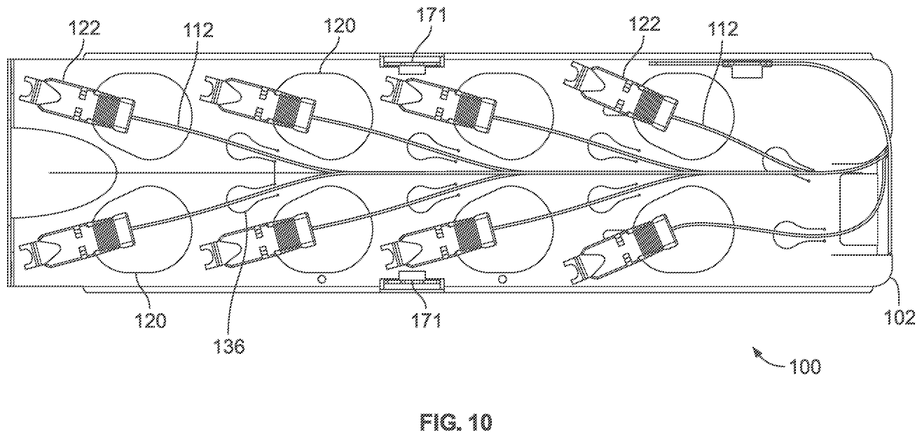

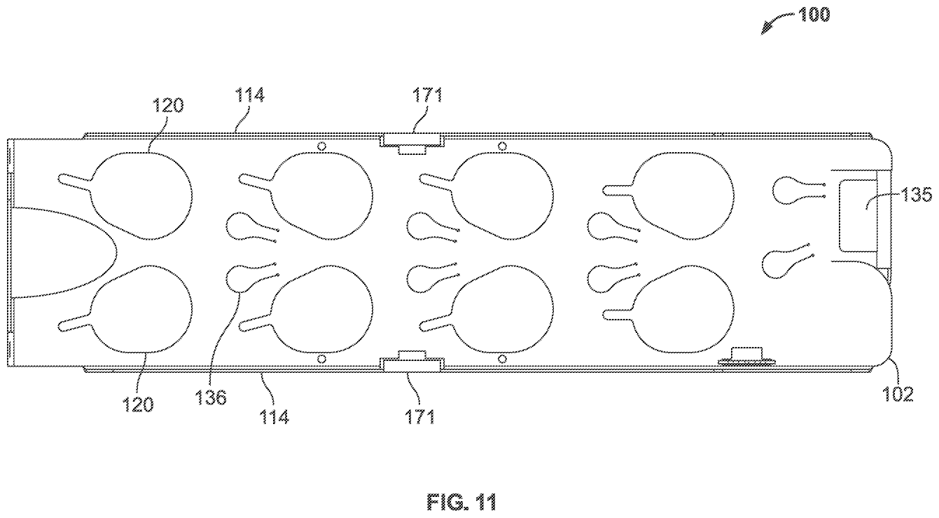

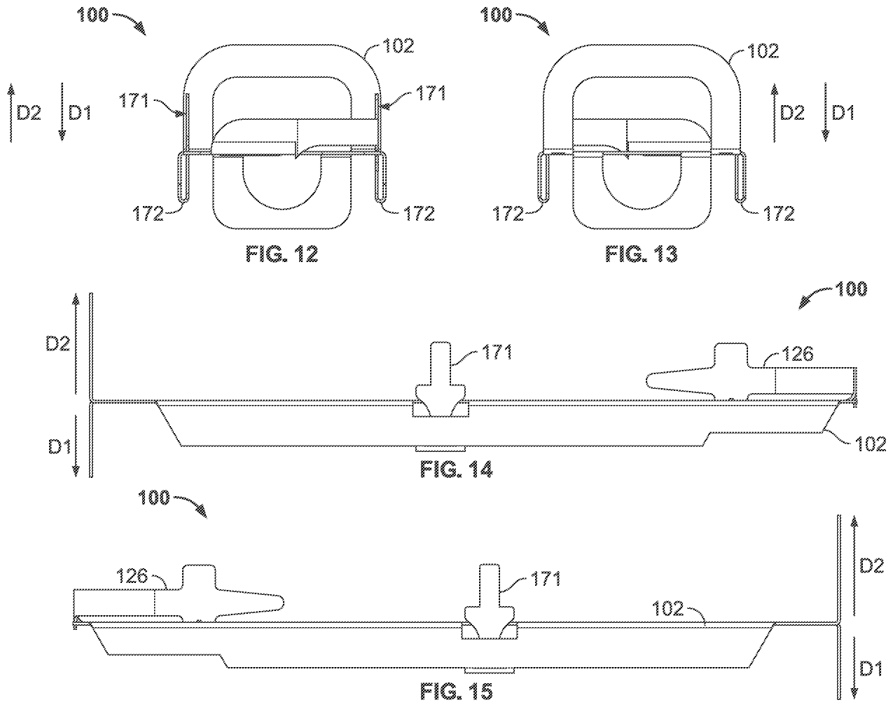

In certain examples, the polymeric substrates 102, 104 can include holders that are unitary parts of the polymeric substrates 102, 104 for holding optical fibers and/or for holding optical components (e.g., passive optical power splitters, passive optical taps, wavelength division multiplexers). In certain examples, the holders are adapted for assisting in retaining optical fibers (e.g., ribbonized optical fibers 113 and optical fibers 152) that are routed about a perimeter of the main body along an inner surface of the housing 22 (e.g., along the housing sides 154, 155). In certain examples, the holders can include clamping structures for clamping optical fibers and/or optical components (e.g., the splice package at the splice location 153). FIGS. 6-9 depict the first polymeric substrate 102 including unitary holders 170 in the form of flaps 171 positioned at opposite sides of the main body 110 adjacent the housing sides 154, 155. In use, optical fibers 113, 152 routed within the housing 22 along the perimeter of the main body 110 between the main body 110 and the base 24 can be retained between the flaps 171 and the sidewalls of the housing sides 154, 155 to maintain the fibers in a looped configuration that loops between the opposite housing ends 44, 46. As depicted, the flaps 171 are connected to the free ends of the side flaps 116 at fold lines 172. The flaps 171 are folded in the second direction D2 at the fold lines 172 relative to the side flaps 116 and extend through openings 173 defined through the main body 110 adjacent the side-flap living hinges 118. The flaps 171 can include tabs 174 that fit through the openings 173 and assist in retaining the flaps 171 in the folded orientation. In certain examples, the flaps 171 can also function as spacers for spacing the main body 110 along the second orientation 146 and ends of the flaps 171 can be configured to engage the base 24.

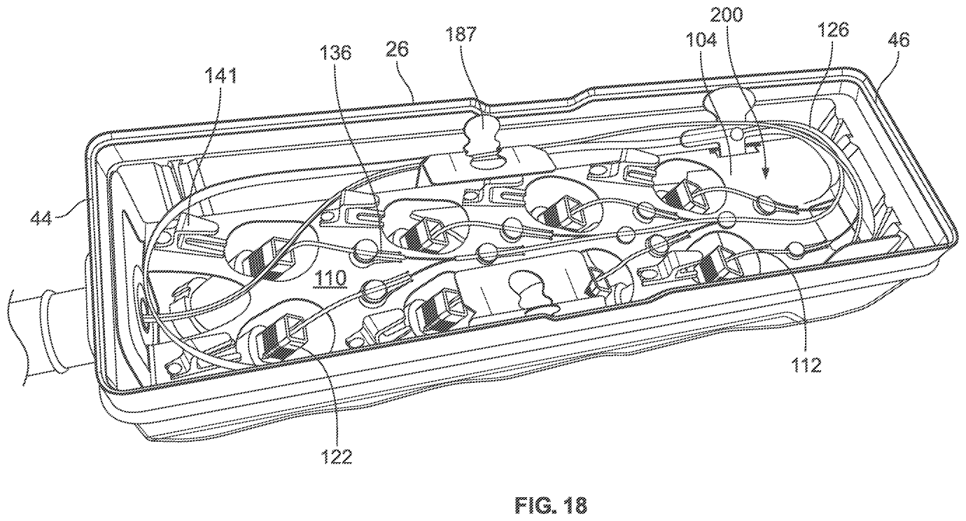

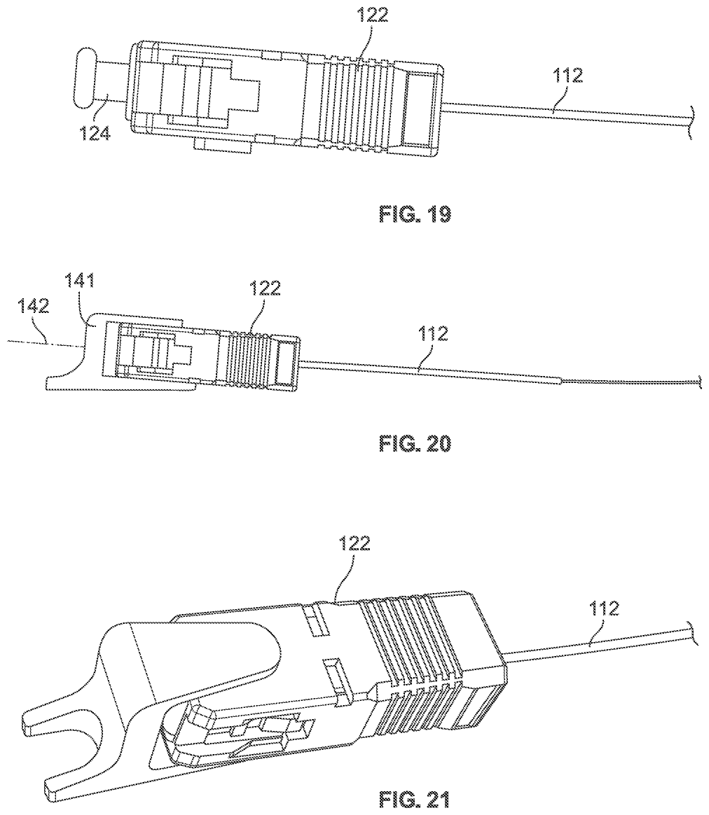

Referring to FIGS. 16-18, the second polymeric substrate 104 includes a holder 180 that is folded to extend across and oppose a portion of the main body 110 (see FIGS. 17 and 18). The holder 180 includes a first flap section 181 and a second flap section 182. The second flap section 182 includes holder arms 184 having base ends 185 that are unitarily connected to the first flap section 181 and free ends 186 that are movable relative to the first flap section 181 such that the optical fibers 113, 152 and/or the optical splice location 153 can be clamped between the holder arms 184 and the first flap section 181. The holder 180 further includes a retaining member 187 that can be displaced from between the holder arms 184 and folded to a retaining position for preventing the items being clamped by the holder 180 from sliding outwardly from between the holder arms 184 and the first flap section 181. In certain examples, an adhesive such as a tacky adhesive can be provided on the holder arms 184 and/or on the first flap section 181 for facilitating holding and retaining the items being held between the holder arms 184 and the first flap section 181. The holder 180 can include a flap portion 188 that connects to a free end of one of the side flaps 116 at a fold line 189. The flap portion 188 can be folded in the second direction D2 relative to the side flap 116 about the fold line 189. Another fold line 190 can be provided between the flap portion 188 and the first flap section 181. A side notch is 191 can align with the fold line 190. The fold line 190 allows the first flap section 181 and the second flap section 182 to be folded relative to the flap portion 188 to a position in which the clamping portion of the holder 180 (e.g., the first and second flap sections 181, 182) overhang the main body 110 of the polymeric substrate 104.

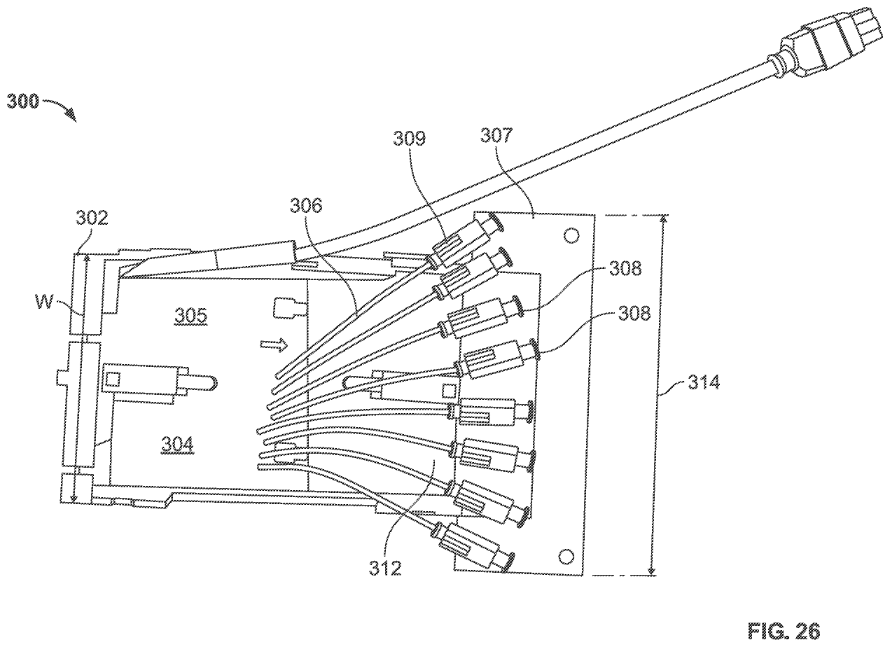

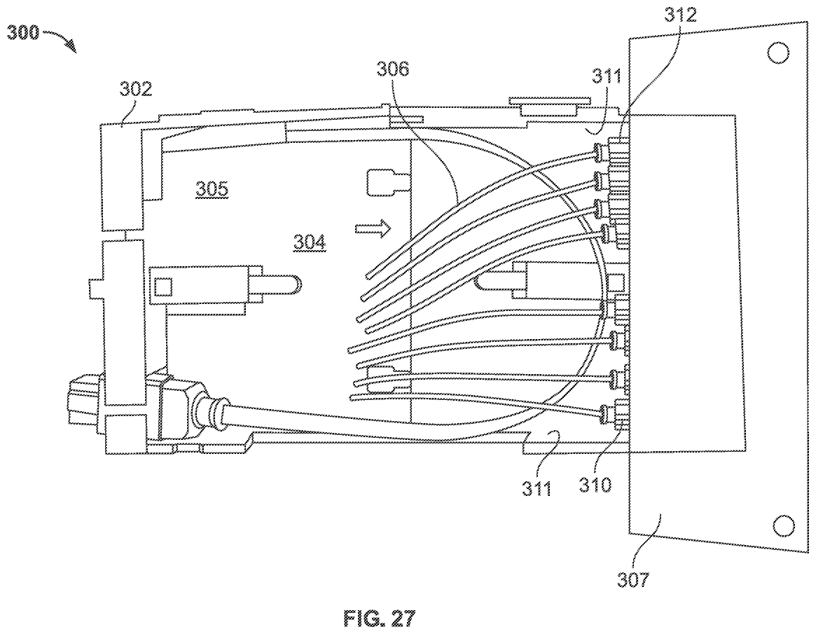

FIGS. 26 and 27 depict another fiber management arrangement 300 adapted for use in a telecommunications enclosure such as a module 302. The fiber management arrangement 300 includes a polymeric substrate 304 including a main body 305. The fiber management arrangements 300 includes a plurality of optical fibers 306 routed on and secured to the main body 305. The polymeric substrate 304 includes a connector staging portion 307 that is detachable from the main body 305. The fiber management arrangement 300 also includes dust caps 308 secured to the connector staging portion 307 for temporarily holding connectorized ends 309 of the optical fibers 306. The module 302 can be an optical connection module including a plurality of fiber optic adapters including connector mounting locations 310 into which the connectorized ends 309 of the fibers can be plugged. The connector staging portion 307 of the polymeric substrate 304 is unitarily connected to the main body 305 by bridge sections 311. The bridge sections 311 can be cut or torn to detach the connector staging portion 307 from the main body 305 after the connectorized ends 309 have been removed from the dust caps 308 and installed in the connector mounting locations 310. When the polymeric substrate 304 is positioned at the module 302, the connector staging portion 307 functions to generally stage the connectorized ends 309 adjacent to the connector mounting locations 310. At least one connector pass-through opening 312 is provided between the connector staging portion 307 and the main body 305 for allowing the connectorized ends 309 to be passed through the polymeric substrate 304 and plugged into the connector mounting locations 310 while the connector staging portion 307 is still attached to the main body 305. After the connectorized ends 309 have been plugged into the connector mounting locations 310, the connector staging portion 307 can be removed from the main body 305. In certain examples, the connector staging portion 307 is larger than the module 302. For example, the connector staging portion 307 can have a dimension 314 that is larger than a width W of the module 302. The increased size of the connector staging portion 307 allows the connectorized ends 309 to be spread (e.g., fanned) apart to allow for better finger access.

In other examples, alternative configurations may be used at the external connector ports. For example, in cases where pigtails may include multi-fiber ferrules such as MPO ferrules that provide alignment via mating male and female ferrules, the connection locations may not include ferrule alignment sleeves. Also, in cases where ferrule-less connectors and ferrule-less fiber alignment systems are used, ferrules may be eliminated from the pigtails. Example ferrule-less connectors and fiber alignment systems are disclosed by International PCT Publication Nos. WO 2020/112645; WO2017/223072; and WO2016/100384 which are hereby incorporated by reference in their entireties.

### Example Aspects of the Disclosure

Aspect 1. A fiber management arrangement for use in a telecommunication enclosure, module, or other structure, the fiber management arrangement including a polymeric substrate including a main body and a plurality of features unitarily connected to the main body (e.g., by flexible regions such as living hinges), the fiber management arrangement including a plurality of optical fibers routed on and secured to the main body.

Aspect 2. The fiber management arrangement of Aspect 1, wherein the main body is elongate along a length and includes sides that extend along the length, and wherein the features includes side flaps that extend along the sides and are connected to the sides by living hinges.

Aspect 3. The fiber management arrangement of Aspects 1 or 2, wherein the optical fibers are secured to the main body by continuous extents of adhesive that extend along lengths of the optical fibers or alternatively by one or more sections of adhesive positioned intermittently along lengths of the optical fibers.

Aspect 4. The fiber management arrangement of any of Aspects 1-3, wherein the optical fibers are part of fiber optic pigtails including at least ferrules secured at ends of the optical fibers or include ferrule-less connectors.

Aspect 5. The fiber management arrangement of Aspect 4, wherein the ferrules are part of fiber optic connectors positioned at the ends of the optical fibers.

Aspect 6. The fiber management arrangement of Aspect 5, wherein the ferrules are single fiber ferrules and the fiber optic connectors include single fiber connectors such as LC connectors or SC connectors, but alternatively could be multi-fiber ferrules that are part of multi-fiber connectors such as MPO connectors.

Aspect 7. The fiber management arrangement of any of Aspects 1-6, wherein the main body defines a plurality of through openings corresponding to connector mounting locations defined by a housing piece of the telecommunication enclosure.

Aspect 8. The fiber management arrangement of Aspect 7, further comprising fiber strain relief flaps positioned adjacent to the through openings, the strain relief flaps having flap lengths that extend between base ends unitarily formed with the main body and free ends, each of the optical fibers being routed along the length and bonded to a corresponding one the strain relief flaps.

Aspect 9. The fiber management arrangement of Aspect 8, wherein the strain relief flaps each extend toward a corresponding one of the through openings in a direction from the base end to the free end.

Aspect 10. The fiber management arrangement of Aspect 8 or 9, wherein the free ends of the strain relief flaps include enlarged heads and the optical fibers are bonded to the enlarged heads.

Aspect 11. The fiber management arrangement of Aspect 10, wherein the enlarged heads are circular in shape.

Aspect 12. The fiber management arrangement of Aspects 7-11, wherein the fiber optic pigtails extend through the through openings and the fiber optic connectors plug into the connector mounting locations.

Aspect 13. The fiber management arrangement of Aspect 12, wherein the connector mounting locations include fiber optic adapters including ferrule alignment sleeves for receiving the ferrules of the fiber optic connectors.

Aspect 14. The fiber management arrangement of and of Aspects 7-13, further comprising dust caps secured to the main body adjacent the through openings for receiving and storing the ferrules of the fiber optic pigtails prior to the fiber optic pigtails being routed through the through openings and plugged into the connector mounting locations, the dust caps being secured to the main body on opposite sides of the through openings from the strain relief flaps

Aspect 15. The fiber management arrangement of Aspect 14, wherein the dust caps are bonded to the main body.

Aspect 16. The fiber management arrangement of Aspect 15, wherein the dust caps include bases bonded to the main body, the bases each including a pair of feet defining bonding surfaces bonded to the main body.

Aspect 17. The fiber management arrangement of Aspect 14, wherein connectorized ends of the fiber optic pigtails are keyed with respect to the dust caps so that the connectorized ends can be inserted into the dust caps in only one rotational orientation.

Aspect 18. The fiber management arrangement of Aspect 14, wherein the dust caps define ferrule storage axes along which the ferrule align when stored in the dust caps, the storage axes being obliquely aligned relative to the main body of the polymeric substrate.

Aspect 19. The fiber management arrangement of any of Aspects 1-18, further comprising a spacer flap for spacing the main body relative to a base and a cover of an enclosure in which the fiber management arrangement is mounted.

Aspect 20. The fiber management arrangement of Aspect 19, wherein the spacer flap is U-shaped.

Aspect 21. The fiber manage arrangement of any of Aspects 1-18, further comprising first and second spacer flaps for spacing the main body relative to a base and a cover of an enclosure in which the fiber management arrangement is mounted.

Aspect 22. The fiber management arrangement of Aspect 21, wherein one of the first and second spacer flaps is folded in a first direction relative the main body and the other of the first and second spacer flaps is folded in an opposite second direction relative the main body.

Aspect 23. The fiber management arrangement of Aspect 22, wherein the first and second spacer flaps are U-shaped, wherein the first and second spacer flaps are nested prior to folding, and wherein the first and second spacer flaps are located at one end of the main body.

Aspect 24. The fiber management arrangement of claim 23, wherein one of the spacer flaps cooperates with the main body to define an opening before and after folding.

Aspect 25. The fiber management arrangement of any of Aspects 1-24, further comprising a fiber guide flap attached to the main body by a flexible region, wherein at least one of the optical fibers is routed on and attached to the fiber guide flap.

Aspect 26. The fiber management arrangement of Aspect 25, wherein the fiber guide flap is folded relative to the main body at the flexible region and forms a sidewall that extends along a portion of a perimeter of the main body.

Aspect 27. The fiber management arrangement of Aspect 26, wherein the fiber guide flap includes a first guide flap portion connected to the main body by a flexible region, wherein the fiber guide flap includes a second guide flap portion not connected to the main body by a flexible region, the second guide flap portion being bent in a curved configuration and functioning to guide the at least one optical fiber along a curve corresponding to a corner of the housing, and the second guide flap portion including a retention tab that fits within an opening defined by the main body to retain the second guide flap portion in the curved configuration.

Aspect 28. The fiber management arrangement of any of Aspects 1-27, further comprising a holder that is a unitary part of the polymeric substrate for holding optical fibers and/or optical components such as a passive optical power splitter, an optical tap, or a wavelength division multiplexer.

Aspect 29. The fiber management arrangement of Aspect 28, wherein the holder includes a holder flap that is folded to extend across and oppose a portion of the main body.

Aspect 30. The fiber management arrangement of Aspect 29, wherein the holder flap includes a first flap section and a second flap section, the second flap section including holder arms having base ends that are unitarily connected to the first section and free ends that are movable relative to the first section such that the optical fibers and/or the optical components can be clamped between the holder arms and first flap section.

Aspect 31. The fiber manager of Aspect 30, further comprising a retaining member displaced from between the first and second holder arms and folded to a retaining position for preventing the optical fibers and/or the optical components from sliding outwardly from between the holder arms and the first flap section.

Aspect 32. The fiber manager of any of aspects 1-30, wherein the living hinges are each defined by a pre-defined weakened fold line formed by scoring, perforations, at least one through-slot or the like.

What is claimed is:

1. A telecommunication enclosure comprising
a housing including a base and a cover that fit together to enclose an interior of the housing, the housing defining a housing length that extends between first and second opposite housing ends, the enclosure including inner connector mounting locations at the cover; and
a fiber management arrangement that mounts within the housing between the base and the cover, the fiber management arrangement including a polymeric substrate including a main body, the fiber management arrangement including a plurality of optical fibers routed on and secured to the main body, the main body being elongate along a manager length that extends along the housing length, the polymeric substrate including sides that extend along the manager length, the polymeric substrate including side flaps that extend along the sides and are connected to the main body by side-flap living hinges, the side flaps being folded in a first direction relative to the main body at the side-flap living hinges and extending from the main body into the cover, the main body defining through openings corresponding to the connector mounting locations through which the optical fibers are routed such that connectorized ends of the optical fibers can be plugged into the inner connector mounting locations at the cover, the polymeric substrate further including a fiber guide flap attached to the main body at a flexible region, wherein at least one of the optical fibers is routed on and attached to the fiber guide flap, and wherein the fiber guide flap is bent in a second direction opposite to the first direction relative to the main body to form a sidewall that extends along a portion of a perimeter of the main body.

2. The telecommunication enclosure of claim 1, wherein the fiber guide flap includes a first guide flap portion connected to the main body by the flexible region, wherein the fiber guide flap includes a second guide flap portion not connected to the main body along its length by a living hinge, the second guide flap portion being bent relative to the first guide flap portion in a curved configuration and functioning to guide the at least one optical fiber along a curve corresponding to a corner of the housing, and the second guide flap portion including a retention tab that fits within an opening defined by the main body to retain the second guide flap portion in the curved configuration.

3. The telecommunication enclosure of claim 1, wherein the optical fibers are each secured to the main body by discrete sections of adhesive positioned intermittently along lengths of the optical fibers.

4. The telecommunication enclosure of claim 1, further comprising fiber strain relief flaps positioned adjacent to the through openings, the strain relief flaps having flap lengths that extend between base ends unitarily formed with the main body and free ends, each of the optical fibers being routed along the housing length and bonded to a corresponding one the strain relief flaps, wherein the strain relief flaps each extend toward a corresponding one of the through openings in a direction from the base end to the free end, and wherein the free ends of the strain relief flaps include enlarged heads and the optical fibers are bonded to the enlarged heads.

5. The telecommunication enclosure of claim 4, wherein the enlarged heads are circular in shape.

6. The telecommunication enclosure of claim 4, further comprising dust caps secured to the main body adjacent the through openings for receiving and storing the connectorized ends of the optical fibers prior to the connectorized ends being routed through the through openings and plugged into the connector mounting locations, the dust caps being secured to the main body on opposite sides of the through openings from the strain relief flaps

7. The telecommunication enclosure of claim 6, wherein the dust caps include bases bonded to the main body, the bases each including a pair of feet defining bonding surfaces bonded to the main body.

8. The telecommunication enclosure of claim 6, wherein the connectorized ends are keyed with respect to the dust caps so that the connectorized ends can be inserted into the dust caps in only one rotational orientation.

9. The telecommunication enclosure of claim 6, wherein the dust caps define ferrule storage axes along which the connectorized ends align when stored in the dust caps, the storage axes being obliquely aligned relative to the main body of the polymeric substrate.

10. The telecommunication enclosure of claim 1, further comprising a spacer flap unitarily connected to the main body by a spacer flap living hinge for spacing the main body relative to the base and the cover.

11. The telecommunication enclosure of claim 10, wherein the spacer flap is U-shaped.

12. The telecommunication enclosure of claim 1, further comprising first and second spacer flaps unitarily connected with the main body at spacer flap living hinges for spacing the main body relative to the base and the cover.

13. The telecommunication enclosure of claim 12, wherein one of the first and second spacer flaps is folded in a first direction relative the main body and the other of the first and second spacer flaps is folded in an opposite second direction relative the main body.

14. The telecommunication enclosure of claim 13, wherein the first and second spacer flaps are U-shaped, wherein the first and second spacer flaps are nested prior to folding, and wherein the first and second spacer flaps are located at one end of the main body.

15. The telecommunication enclosure of claim 14, wherein one of the spacer flaps cooperates with the main body to define a fiber pass-through opening before and after folding.

16. The telecommunication enclosure of claim 1, further comprising a holder that is a unitary part of the polymeric substrate for holding optical fibers and/or optical components.

17. The telecommunication enclosure of claim 16, wherein the holder includes a holder flap that is folded to extend across and oppose a portion of the main body.

18. The telecommunication enclosure of claim 17, wherein the holder flap includes a first flap section and a second flap section, the second flap section including holder arms having base ends that are unitarily connected to the first section and free ends that are movable relative to the first section such that the optical fibers and/or the optical components can be clamped between the holder arms and first flap section.

19. The telecommunication enclosure of claim 18, further comprising a retaining member displaced from between the first and second holder arms and folded to a retaining position for preventing the optical fibers and/or the optical components from sliding outwardly from between the holder arms and the first flap section.

20. The telecommunication enclosure of claim 1, wherein the telecommunication enclosure includes a plurality of fiber optic adapters carried with the cover for coupling hardened connectors inserted into the fiber optic adapters from outside the housing to the connectorized ends plugged into the inner connector mounting locations, wherein the fiber optic adapters define the inner connector mounting locations.

21. The telecommunication enclosure of claim 20, wherein the fiber optic adapters include ferrule alignment sleeves having outer ends for receiving ferrules of the hardened connectors inserted to the fiber optic adapters from outside the housing, and wherein the inner connector mounting locations correspond to inner ends of the ferrule alignment sleeves.

22. A fiber management arrangement for use in a telecommunication enclosure, the fiber management arrangement including a polymeric substrate including a main body, the fiber management arrangement including a plurality of optical fibers routed on and secured to the main body, the polymeric substrate including a connector staging portion that is detachable from the main body, the fiber management arrangement including dust caps secured to the connector staging portion for temporarily holding connectorized ends of the optical fibers.

23. The fiber management arrangement of claim 22, wherein the connector staging portion of the polymeric substrate is unitarily connected to the main body by bridge sections, and wherein the bridge sections can be cut or torn to detach the connector staging portion from the main body.

24. The fiber management arrangement of claim 23, wherein at least one connector pass-through opening is defined between the main body and the connector staging portion of the polymeric substrate.
